(19) United States
(12) Patent Application Publication
(10) Pub. No.: US 2019/0023887 A1
(43) Pub. Date: Jan. 24, 2019

(54) RESIN COMPOSITION AND MOLDED ARTICLE

(71) Applicant: FUJI XEROX CO.,LTD., Tokyo (JP)

(72) Inventor: Ryo TANAKA, Kanagawa (JP)

(73) Assignee: FUJI XEROX CO.,LTD., Tokyo (JP)

(21) Appl. No.: 15/947,873

(22) Filed: Apr. 9, 2018

(30) Foreign Application Priority Data
Jul. 20, 2017 (JP) 2017-141216

(51) Int. Cl. C08L 25/12; C08L 33/20; C08L 1/12; C08F 220/44; C08L 33/10; C08L 33/08

(52) U.S. Cl. CPC C08L 25/12; C08L 33/20; C08L 1/12; C08L 2205/03; C08L 33/10; C08L 33/08; C08F 2500/01; C08F 220/44

(57) ABSTRACT

A resin composition includes a cellulose ester compound and a styrene-acrylonitrile resin having a weight average molecular weight of 50,000 or greater and 200,000 or less.

### CROSS-REFERENCE TO RELATED APPLICATIONS

This application is based on and claims priority under 35 USC 119 from Japanese Patent Application No. 2017-141216 filed Jul. 20, 2017.

### BACKGROUND

### (i) Technical Field

The present invention relates to a resin composition and a molded article.

### (ii) Related Art

Various thermoplastic resins have been provided and used for many purposes. For example, thermoplastic resins are used for various components of home appliances or vehicles, or housings of office equipment or electronic or electric equipment.

In recent years, plant-derived resins have been used as thermoplastic resins, and a cellulose ester compound is a plant-derived resin which has been known.

The cellulose ester compound may be used alone or used as a resin composition by being mixed with a resin other than the cellulose ester compound.

### SUMMARY

According to an aspect of the invention, there is provided a resin composition including a cellulose ester compound and a styrene-acrylonitrile resin having a weight average molecular weight of 50,000 or greater and 200,000 or less.

### DETAILED DESCRIPTION

Hereinafter, exemplary embodiments of the invention will be described in detail.

Resin Composition

A resin composition according to this exemplary embodiment includes a cellulose ester compound and a styrene-acrylonitrile resin (hereinafter, may also be referred to as “specific resin”) having a weight average molecular weight of 50,000 or greater and 200,000 or less.

According to the resin composition according to this exemplary embodiment, the tensile break strain of a molded article to be obtained is higher than in a case where only a cellulose ester compound and a styrene-acrylonitrile resin having a weight average molecular weight exceeding 200,000 are included. The reason for this is not clear, but presumed as follows.

Regarding a styrene-acrylonitrile resin having a weight average molecular weight of 50,000 or greater, the styrene-acrylonitrile resin itself has a high tensile break strain. Accordingly, the tensile break strain of a molded article to be obtained is thought to be high even in a case where the styrene-acrylonitrile resin is mixed with a cellulose ester compound.

In addition, there is a tendency for the tensile break strain of the styrene-acrylonitrile resin itself to increase as the weight average molecular weight increases.

However, in a case where a styrene-acrylonitrile resin having a weight average molecular weight which is not too high (specifically, a weight average molecular weight of 200,000 or less) is used in mixing with a cellulose ester compound, the tensile break strain of a molded article to be obtained is further improved.

The reason for the improvement in tensile break strain is presumed to be that since the weight average molecular weight of the styrene-acrylonitrile resin is 200,000 or less, miscibility between the cellulose ester compound and the styrene-acrylonitrile resin is excellent, and the cellulose ester compound and the styrene-acrylonitrile resin are mixed in a substantially uniform state.

The reason why the miscibility is excellent is thought to be that since the weight average molecular weight of the styrene-acrylonitrile resin is 200,000 or less, a molecular chain of the styrene-acrylonitrile resin and a molecular chain of the cellulose ester compound are likely to be entangled, and since the viscosity of the styrene-acrylonitrile resin during kneading is lower than in a case where the weight average molecular weight is greater than 200,000, the kneading is easily performed.

In addition, the specific resin has higher stiffness than the cellulose ester compound. Accordingly, it is thought that in a case of a resin composition obtained by mixing the cellulose ester compound and the specific resin, the tensile elastic modulus of a molded article to be obtained is more likely to increase than in a case of a resin composition obtained using a cellulose ester compound alone.

Moreover, in a case where a resin composition obtained by mixing two or more kinds of resins is used, light interference may occur at an interface between the resins mixed therewith, and thus pearly luster may be generated in a molded article to be obtained. In the resin composition according to this exemplary embodiment, the cellulose ester compound and the specific resin are mixed in a substantially uniform state as described above, and thus it is thought that the light interference hardly occurs, and the generation of pearly luster is likely to be suppressed in a molded article to be obtained.

In a case where the resin composition further contains an elastomer, the elastomer is dispersed in a substantially uniform state in both of a phase of the cellulose ester compound and a phase of the specific resin. Accordingly, it is thought that cracking hardly occurs in a molded article to be obtained, and the tensile break strain, the tensile elastic modulus, and the Charpy impact strength of the molded article to be obtained are likely to increase.

The components included in the resin composition according to this exemplary embodiment will be described in detail.

In this specification, regarding the amount of a component in a composition, in a case where the component in the composition corresponds to plural substances, the amount of the component means a total amount of the plural substances existing in the composition unless otherwise noted.

In this specification, the “(meth)acrylic acid” means “an acrylic acid or a methacrylic acid”.

Cellulose Ester Compound

The resin composition according to this exemplary embodiment contains a cellulose ester compound.

The cellulose ester compound is a cellulose derivative in which at least a part of hydroxyl groups is substituted with acetyl groups. Specifically, the cellulose ester compound is, for example, preferably a cellulose derivative represented by Formula (1).

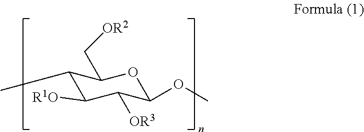

In Formula (1), R¹, R², and R³ each independently represent a hydrogen atom or an acyl group. n represents an integer of 2 or more. At least a part of n R¹, n R², and n R³ represents an acyl group.

In Formula (1), the range of n is not particularly limited. n may be determined in accordance with a target weight average molecular weight range. For example, n is 120 or greater and 800 or less.

The compound represented by Formula (1) includes, for example, preferably at least one selected from the group consisting of an acetyl group, a propionyl group, and a butyryl group, more preferably at least one selected from the group consisting of a propionyl group and a butyryl group, and even more preferably an acetyl group and at least one selected from the group consisting of a propionyl group and a butyryl group as the acyl group included in R¹, R², or R³.

That is, for example, it is preferable that the cellulose ester compound used in this exemplary embodiment includes at least one selected from the group consisting of cellulose acetate propionate and cellulose acetate butyrate.

Weight Average Molecular Weight

The weight average molecular weight of the cellulose ester compound used in this exemplary embodiment is, for example, preferably 30,000 or greater and 300,000 or less, and more preferably 70,000 or greater and 250,000 or less in view of suppressing a reduction in heat resistance of a molded article and improving fluidity.

In this specification, the weight average molecular weight (Mw) is a value measured in terms of polystyrene using tetrahydrofuran with a gel permeation chromatography apparatus (GPC apparatus: manufactured by TOSOH CORPORATION, HLC-8320GPC, Column: TSKgel α-M) unless otherwise noted.

Substitution Degree

The substitution degree of the cellulose ester compound used in this exemplary embodiment is, for example, preferably 2.1 or greater and 2.9 or less, and more preferably 2.2 or greater and 2.8 or less.

Here, the substitution degree is an index indicating the degree of substitution of the hydroxyl group of the cellulose with an acyl group. That is, the substitution degree is an index indicating the acylation degree of the cellulose ester compound. Specifically, the substitution degree means an average number of substitutions in the molecule, in which three hydroxyl groups on the D-glucopyranose unit of the cellulose ester compound are substituted with acyl groups.

The substitution degree is measured from the integration ratio of the peak derived from the acyl group and the hydrogen derived from the cellulose with the use of H¹-NMR (JNM-ECA/manufactured by JEOL RESONANCE Inc.). For example, in a case where the degree of substitution with acetyl group is 2.4, the constituent unit molecular weight of the cellulose ester compound having an acetyl group as a substituent is 263, and in a case where the degree of substitution with acetyl group is 2.9, the constituent unit molecular weight is 284.

In this specification, in a case where the cellulose ester compound is substituted with plural kinds of acyl groups such as an acetyl group, a propionyl group, and a butyryl group, an average number of substitutions in the molecule, in which three hydroxyl groups on the D-glucopyranose unit of the cellulose ester compound are substituted with acetyl groups may also be referred to as a degree of substitution with acetyl group, an average number of substitutions with propionyl group in the molecule may also be referred to as a degree of substitution with propionyl group, and an average number of substitutions with butyryl group in the molecule may also be referred to as a degree of substitution with butyryl group.

In the cellulose ester compound used in this exemplary embodiment, for example, it is preferable that the degree of substitution with acetyl group is 0.05 or greater and 2.85 or less and the degree of substitution with propionyl group is 0.05 or greater and 2.85 or less, or it is preferable that the degree of substitution with acetyl group is 0.05 or greater and 2.85 or less and the degree of substitution with butyryl group is 0.05 or greater and 2.85 or less.

Polymerization Degree

The polymerization degree of the cellulose ester compound may be, for example, 120 or greater and 800 or less, 200 or greater and 750 or less, or 250 or greater and 700 or less. In a case where the polymerization degree of the cellulose ester compound is within the above range, a resin composition in which a reduction in heat resistance of a molded article is suppressed and fluidity is improved is likely to be obtained.

The polymerization degree of the cellulose ester compound is obtained from a weight average molecular weight in accordance with the following procedures.

First, the weight average molecular weight of the cellulose ester compound is measured by the above-described method.

Next, the weight average molecular weight is divided by the skeleton molecular weight of the cellulose ester compound to obtain the polymerization degree of the cellulose ester compound.

The skeleton molecular weight of the cellulose ester compound is calculated from the above-described substitution degree.

Producing Method

The method of producing the cellulose ester compound is not particularly limited. For example, the cellulose ester compound may be produced by performing acylation, molecular weight reduction (depolymerization), and if necessary, deacylation on cellulose. A commercially available cellulose ester compound may be used after being subjected to molecular weight reduction (depolymerization) so as to obtain a predetermined weight average molecular weight.

Content

Preferably, the resin composition according to this exemplary embodiment contains the cellulose ester compound in an amount of, for example, 60 mass % or greater and 95 mass % or less, and more preferably in an amount of 70 mass % or greater and 85 mass % or less with respect to the total mass of the resin composition from the viewpoint of increasing the tensile break strain of a molded article to be obtained.

The resin composition according to this exemplary embodiment may contain one or more kinds of cellulose ester compounds.

Specific Resin

The resin composition according to this exemplary embodiment includes a styrene-acrylonitrile resin (specific resin) having a weight average molecular weight of 50,000 or greater and 200,000 or less.

In this exemplary embodiment, the weight average molecular weight of the styrene-acrylonitrile resin is measured using tetrahydrofuran (THF) and polystyrene (TSK standard POLYSTYRENE) as a standard substance with a GPC apparatus (manufactured by TOSOH CORPORATION, HLC-8320GPC, Column: TSKgel α-M).

The specific resin is a resin containing a constituent unit derived from a styrene compound and a constituent unit derived from an acrylonitrile compound in a main chain.

In the specific resin, a total content of the constituent unit derived from a styrene compound and the constituent unit derived from an acrylonitrile compound is, for example, preferably 80 mass % or greater and 100 mass % or less, more preferably 90 mass % or greater and 100 mass % or less, and even more preferably 95 mass % or greater and 100 mass % or less with respect to the total mass of the resin.

The content of the constituent unit derived from a styrene compound in the specific resin is, for example, preferably 5 mass % or greater and 90 mass % or less, and more preferably 20 mass % or greater and 80 mass % or less with respect to the total mass of the styrene-acrylonitrile resin.

The content of the constituent unit derived from an acrylonitrile compound in the styrene-acrylonitrile resin is, for example, preferably 5 mass % or greater and 50 mass % or less, and more preferably 10 mass % or greater and 40 mass % or less with respect to the total mass of the styrene-acrylonitrile resin.

As the styrene compound, for example, unsubstituted styrene or styrene having a substituent is preferable, styrene, 4-bromostyrene, perfluorostyrene, α-methylstyrene, vinyltoluene, or the like is more preferable, and styrene is even more preferable.

As the acrylonitrile compound, for example, unsubstituted acrylonitrile or acrylonitrile having a substituent is preferable, and acrylonitrile is more preferable.

Weight Average Molecular Weight

The weight average molecular weight of the specific resin is, for example, preferably 80,000 or greater, and more preferably greater than 100,000.

The weight average molecular weight of the styrene-acrylonitrile resin is, for example, preferably 180,000 or less, and more preferably 160,000 or less.

Other Constituent Units

The specific resin may include other constituent units. Examples of other constituent units include a constituent unit derived from a compound having a (meth)acryloyl group, and for example, a constituent unit derived from a (meth)acrylic acid ester compound is preferable.

The content of other constituent units in the specific resin is, for example, preferably 30 mass % or less, more preferably 20 mass % or less, and even more preferably 10 mass % or less with respect to the total mass of the specific resin, and it is particularly preferable that no other constituent units are contained.

Content

In the resin composition according to this exemplary embodiment, the ratio of the total mass of the specific resin with respect to a total of the total mass of the cellulose ester compound and the total mass of the specific resin is, for example, preferably 0.05 or greater and 0.35 or less, and more preferably 0.10 or greater and 0.30 or less from the viewpoint of improving the tensile break strain of a molded article to be obtained.

Thermoplastic Elastomer

Preferably, the resin composition according to this exemplary embodiment further includes, although not particularly limited, a thermoplastic elastomer having a constituent unit derived from a (meth)acrylic acid ester compound.

The thermoplastic elastomer refers to a thermoplastic resin having rubbery elasticity, and preferably has, for example, a hard segment formed of a constituent unit derived from a (meth)acrylic acid ester compound and a soft segment formed of another constituent unit.

Constituent Unit Derived from (Meth)acrylic Acid Ester Compound

The constituent unit derived from a (meth)acrylic acid ester compound in the thermoplastic elastomer is not particularly limited, and is preferably, for example, a constituent unit derived from an alkyl (meth)acrylate compound (alkyl (meth)acrylate).

As the constituent unit derived from an alkyl (meth)acrylate compound, although not particularly limited, a constituent unit represented by Formula (a) is preferable.

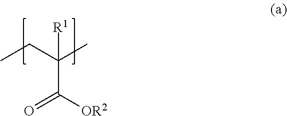

In Formula (a), R¹ represents a hydrogen atom or a methyl group. R² represents an alkyl group having 1 to 10 carbon atoms.

In Formula (a), R² is, for example, preferably an alkyl group having 1 to 6 carbon atoms, more preferably an alkyl group having 1 to 4 carbon atoms, even more preferably a methyl group or an ethyl group, and particularly preferably a methyl group from the viewpoint of the tensile elastic modulus and the Charpy impact strength of a molded article to be obtained. In addition, from the viewpoint of moldability and the tensile elastic modulus of a molded article to be obtained, R² is, for example, more preferably an alkyl group having 1 to 6 carbon atoms, and even more preferably an alkyl group having 1 to 4 carbon atoms.

In R², the alkyl group may be a linear alkyl group or a branched alkyl group.

The thermoplastic elastomer may have one or more kinds of constituent units represented by Formula (a).

The content of the constituent unit represented by Formula (a) in the thermoplastic elastomer is, for example, preferably 5 mass % or greater and 50 mass % or less, more preferably 10 mass % or greater and 40 mass % or less, and particularly preferably 15 mass % or greater and 35 mass % or less with respect to the total mass of the copolymer.

Constituent Unit Derived from Olefin Compound

In addition, the thermoplastic elastomer preferably includes, although not particularly limited, a constituent unit derived from an olefin compound.

The constituent unit derived from an olefin compound is, for example, preferably a constituent unit derived from an aliphatic hydrocarbon compound having an ethylenically unsaturated group, more preferably a constituent unit derived from at least one compound selected from the group consisting of ethylene, α-olefin, and butadiene, even more preferably a constituent unit derived from at least one compound selected from the group consisting of ethylene and butadiene, and particularly preferably ethylene.

The thermoplastic elastomer may have one or more kinds of constituent units derived from an olefin compound.

The content of the constituent unit derived from an olefin compound in the thermoplastic elastomer is, for example, preferably 55 mass % or greater and 85 mass % or less, more preferably 65 mass % or greater and 85 mass % or less, and particularly preferably 68 mass % or greater and 80 mass % or less with respect to the total mass of the thermoplastic elastomer from the viewpoint of the tensile elastic modulus and the Charpy impact strength of a molded article to be obtained.

Other Constituent Units

The thermoplastic elastomer may further contain other constituent units.

Examples of other constituent units include a constituent unit derived from a styrene compound and a constituent unit derived from a maleic anhydride compound.

As the styrene compound, for example, styrene, 4-bromostyrene, perfluorostyrene, α-methylstyrene, or vinyl toluene is preferable, and styrene is more preferable.

As the maleic anhydride compound, for example, maleic anhydride or 2,3-dimethyl maleic anhydride is preferable, and maleic anhydride is more preferable.

In a case where the thermoplastic elastomer includes other constituent units, the content of other constituent units is, for example, preferably 2 mass % or greater and 30 mass % or less, and more preferably 5 mass % or greater and 20 mass % or less with respect to the total mass of the thermoplastic elastomer.

Examples of the thermoplastic elastomer include a (meth)acrylic acid ester compound-olefin-styrene compound copolymer, an olefin-(meth)acrylic acid ester compound copolymer, and an olefin-(meth)acrylic acid ester compound-maleic anhydride compound copolymer. A methyl methacrylate-butadiene-styrene copolymer (MBS resin), an ethylene-methyl acrylate-glycidyl methacrylate copolymer, an ethylene-methyl acrylate copolymer, or an ethylene-methyl acrylate-maleic anhydride copolymer is preferable.

Weight Average Molecular Weight

The weight average molecular weight Mw of the thermoplastic elastomer is, for example, preferably 10,000 or greater and 500,000 or less, and more preferably 50,000 or greater and 300,000 or less from the viewpoint of fluidity and the tensile break strain and the Charpy impact strength of a molded article to be obtained.

Core-Shell Structure

The thermoplastic elastomer used in this exemplary embodiment may have a core-shell structure having a core part and a shell layer. In a case where the thermoplastic elastomer has a core-shell structure, it is thought that the thermoplastic elastomer in the resin composition has improved dispersibility, and the tensile elastic modulus and the Charpy impact strength of a molded article to be obtained are more easily improved.

In a case where the thermoplastic elastomer has a core-shell structure, at least one of the core part or the shell layer may be a thermoplastic elastomer. For example, it is preferable that the thermoplastic elastomer has the above-described thermoplastic elastomer or an acrylic acid ester compound copolymer as the core part, and has another resin as the shell layer.

The above-described another resin is not particularly limited. For example, a thermoplastic resin having high hardness is preferable, a (meth)acrylic resin, a styrene resin, a styrene-acrylic resin, an olefin resin, or the like is more preferable, and methyl polymethacrylate or a methyl methacrylate-styrene copolymer is even more preferable.

In a case where the thermoplastic elastomer has a core-shell structure, the content of the shell is preferably, for example, 5 mass % or greater and 30 mass % or less with respect to the total mass of the thermoplastic elastomer.

Content

The resin composition according to an exemplary embodiment of the present disclosure may contain one or more kinds of the thermoplastic elastomers.

In the resin composition according to an exemplary embodiment of the present disclosure, a ratio of the total mass of the thermoplastic elastomer with respect to a total of the total mass of the cellulose ester compound and the total mass of the specific resin is, for example, preferably 0.01 or greater and 0.20 or less, and more preferably 0.02 or greater and 0.15 or less from the viewpoint of the tensile elastic modulus and the Charpy impact strength of a molded article to be obtained.

Plasticizer

The resin composition according to this exemplary embodiment may further include a plasticizer.

Examples of the plasticizer include an adipic acid ester-containing compound, a polyether ester compound, a condensed phosphoric acid ester compound, a sebacic acid ester compound, a glycol ester compound, an acetic acid ester compound, a dibasic acid ester compound, a phosphoric acid ester compound, a phthalic acid ester compound, camphor, a citric acid ester compound, a stearic acid ester compound, metallic soap, a polyol compound, and a polyalkylene oxide compound.

Among these, for example, an adipic acid ester-containing compound and a polyether ester compound are preferable, and an adipic acid ester-containing compound is more preferable. For example, the plasticizer disclosed in JP2016-183321A can be used.

In a case where a plasticizer is included in the resin composition according to this exemplary embodiment, the content thereof with respect to the total amount of the resin composition is not particularly limited. The content may be 15 mass % or less (for example, preferably 10 mass % or less, and more preferably 5 mass % or less) with respect to the total amount of the resin composition in view of the fact that a reduction in heat resistance of a molded article is suppressed and a resin composition having improved fluidity is likely to be obtained even in a case where the plasticizer is contained. In a case where the content of the plasticizer is within the above range, bleeding of the plasticizer is likely to be suppressed.

Other Components

The resin composition according to this exemplary embodiment may further include a component other than the above-described components if necessary. Examples of the component include a flame retardant, a compatibilizer, an antioxidant, a release agent, a light-resistant agent, a weather-resistant agent, a colorant, a pigment, a modifier, a drip preventing agent, an antistatic agent, a hydrolysis inhibitor, a filler, and a reinforcing agent (glass fiber, carbon fiber, talc, clay, mica, glass flakes, milled glass, glass beads, crystalline silica, alumina, silicon nitride, aluminum nitride, boron nitride, and the like).

If necessary, a component (additive) such as an acid acceptor for preventing acetic acid release or a reactive trapping agent may be added. Examples of the acid acceptor include oxides such as magnesium oxide and aluminum oxide; metallic hydroxides such as magnesium hydroxide, calcium hydroxide, aluminum hydroxide, and hydrotalcite; calcium carbonate; and talc.

Examples of the reactive trapping agent include epoxy compounds, acid anhydride compounds, and carbodiimides.

The content of each of these components is, for example, preferably 0 mass % or greater and 5 mass % or less with respect to the total amount of the resin composition. Here, “0 mass %” means that the resin composition does not contain other components.

The resin composition according to this exemplary embodiment may contain a resin other than the above-described resins (cellulose ester compound and specific resin). In a case where other resins are contained, the content of other resins with respect to the total amount of the resin composition may be, for example, 5 mass % or less, and is preferably less than 1 mass %. Although not particularly limited, it is more preferable that other resins are not contained (that is, 0 mass %).

Examples of other resins include thermoplastic resins which have been known, and specific examples thereof include polycarbonate resins; polypropylene resins; polyester resins; polyolefin resins; polyester carbonate resins; polyphenylene ether resins, polyphenylene sulfide resins; polysulfone resins; polyether sulfone resins; polyarylene resins; polyether imide resins; polyacetal resins; polyvinyl acetal resins; polyketone resins; polyether ketone resins; polyether ether ketone resins; polyaryl ketone resins; polyether nitrile resins; liquid crystal resins; polybenzimidazole resins; polyparabanic acid resins; vinyl polymers or copolymers obtained by polymerizing or copolymerizing one or more kinds of vinyl monomers selected from the group consisting of aromatic alkenyl compounds, methacrylic acid esters, acrylic acid esters, and vinyl cyanide compounds; diene-aromatic alkenyl compound copolymers; vinyl cyanide-diene-aromatic alkenyl compound copolymers; aromatic alkenyl compound-diene-vinyl cyanide-N-phenyl maleimide copolymers; vinyl cyanide-(ethylene-diene-propylene (EPDM))-aromatic alkenyl compound copolymers; vinyl chloride resins; and chlorinated vinyl chloride resins. A core-shell-type butadiene-methyl methacrylate copolymer is also included. These resins may be used alone or in combination of two or more kinds thereof.

Method of Producing Resin Composition

The method of producing the resin composition according to this exemplary embodiment is not particularly limited. The resin composition may be produced by melt-kneading a mixture including a cellulose ester compound, a specific resin, and if necessary, a thermoplastic elastomer having a constituent unit derived from a (meth)acrylic acid ester compound, a plasticizer and other components. The resin composition according to this exemplary embodiment may also be produced by dissolving the above-described components in a solvent.

Examples of the unit for melt-kneading include known units. Specific examples thereof include a twin-screw extruder, a HENSCHEL MIXER, a BANBURY MIXER, a single-screw extruder, a multi-screw extruder, and a co-kneader.

Molded Article

A molded article according to this exemplary embodiment is provided by molding the resin composition according to this exemplary embodiment. That is, the molded article is obtained by molding a resin composition including a cellulose ester compound and a styrene-acrylonitrile resin having a weight average molecular weight of 50,000 or greater and 200,000 or less.

As the method of molding a molded article according to this exemplary embodiment, although not particularly limited, injection molding is preferable in view of high shape flexibility. Regarding this, the molded article is, although not particularly limited, preferably an injection molded article obtained by injection molding.

The cylinder temperature in the injection molding is, for example, 200° C. or higher and 300° C. or lower, and preferably 240° C. or higher and 280° C. or lower. The mold temperature in the injection molding is, for example, 40° C. or higher and 90° C. or lower, and preferably 60° C. or higher and 80° C. or lower.

The injection molding may be performed using commercially available equipment, such as NEX500 manufactured by NISSEI PLASTIC INDUSTRIAL CO., LTD., NEX150 manufactured by NISSEI PLASTIC INDUSTRIAL CO., LTD., NEX70000 manufactured by NISSEI PLASTIC INDUSTRIAL CO., LTD., PNX40 manufactured by NISSEI PLASTIC INDUSTRIAL CO., LTD., or SE50D manufactured by SUMITOMO HEAVY INDUSTRIES, LTD.

The molding method for obtaining a molded article according to this exemplary embodiment is not limited to the above-described injection molding, and for example, extrusion, blow molding, hot press molding, calendaring, coating molding, cast molding, dipping molding, vacuum molding, transfer molding, or the like may be applied.

The molded article according to this exemplary embodiment may be used for electronic equipment, electric equipment, office equipment, home appliances, automobile interior materials, toys, containers, or the like. More specifically, the molded article is used for housings of electronic equipment, electric equipment, or home appliances; various components of electronic equipment, electric equipment, or home appliances; interior parts of automobiles; toy blocks; plastic model kits; storage cases of CD-ROMs, DVDs, or the like; dishes; beverage bottles; food trays; wrapping materials; films; or sheets.

### Examples

Hereinafter, this exemplary embodiment will be described in detail with reference to examples, but is not limited to these examples. In the following description, “parts” and “%” are based on the mass unless otherwise noted.

Preparation of Cellulose Ester Compound

Cellulose acetate propionate (manufactured by EASTMAN CHEMICAL COMPANY, CAP482-20), cellulose acetate butyrate (manufactured by EASTMAN CHEMICAL COMPANY, CAB171-15), cellulose acetate butyrate (manufactured by EASTMAN CHEMICAL COMPANY, CAP381-20), and cellulose acetate (manufactured by DAICEL CORPORATION, L-50), which are commercially available, were prepared as (CE1), (CE2), (CE3), and (CE4), respectively. The substitution degrees of these cellulose ester compounds are described in Table 1. In the table, DS (Ac), DS (Pr), and DS (Bt) represent a degree of substitution with acetyl group, a degree of substitution with propionyl group, and a degree of substitution with butyryl group, respectively.

TABLE 1

| Cellulose Ester | | | |
|---|---|---|---|
| Compound | DS (Ac) | DS (Pr) | DS (Bt) |
| CE1 | 0.18 | 2.49 | — |
| CE2 | 2.07 | — | 0.73 |
| CE3 | 1.05 | — | 1.74 |
| CE4 | 2.45 | — | — |

Preparation of Plasticizer

A commercially available adipic acid ester-containing compound plasticizer (manufactured by DAIHACHI CHEMICAL INDUSTRY CO., LTD., Daifatty 121) was prepared as (PL1).

Preparation of Specific Resin

AS1 and AS6

A commercially available acrylonitrile-styrene copolymer resin (manufactured by TORAY INDUSTRIES, INC., TOYOLAC AS25C-300) and a commercially available acrylonitrile-styrene copolymer resin (manufactured by Asahi Kasei Corporation, STYLAC AS783) were prepared as a specific resin AS1 and a specific resin AS6, respectively.

AS2 to AS5

744 g of styrene, 372 g of acrylonitrile, 216 g of ethylbenzene, 0.18 g of t-butylperoxyisopropylmonocarbonate, and 2.32 g of n-dodecyl mercaptan were mixed under a nitrogen atmosphere to prepare a monomer solution. The solution was put into a glass reaction container (volume: 2 L) and reacted for 7 hours at 120° C. under a nitrogen atmosphere. The obtained polymer solution and methanol were mixed with a homogenizer, and then left. The precipitate was dried for 6 hours or longer at 120° C. by a circulation type dryer, and a specific resin AS2 was obtained. Specific resins AS3 to AS5 were obtained by performing the same operation, except that the amount of n-dodecyl mercaptan was changed to 2.04 g, 0.72 g, and 0.22 g, respectively.

Measurement of Weight Average Molecular Weight

The weight average molecular weights of the specific resins AS1 to AS6 were measured using tetrahydrofuran (THF) and using polystyrene (TSK standard POLYSTYRENE) as a standard substance with a GPC apparatus (manufactured by TOSOH CORPORATION, HLC-8320GPC, Column: TSKgel α-M). The measurement results are described in Table 2.

TABLE 2

| Specific Resin | Weight Average Molecular Weight |
|---|---|
| AS1 | 114,000 |
| AS2 | 43,000 |
| AS3 | 52,000 |
| AS4 | 131,000 |
| AS5 | 182,000 |
| AS6 | 215,000 |

Preparation of Thermoplastic Elastomer

A MBS elastomer (manufactured by MITSUBISHI RAYON CO., LTD., METABLEN C-223A) having a core-shell structure with a methyl methacrylate unit included in a shell was prepared as a thermoplastic elastomer EL1, an acrylic elastomer (manufactured by MITSUBISHI RAYON CO., LTD., METABLEN W-600A) having a core-shell structure with a methyl methacrylate unit included in a shell was prepared as a thermoplastic elastomer EL2, an ethylene-methyl acrylate-glycidyl methacrylate copolymer (manufactured by ARKEMA K. K., lotader AX8900) was prepared as a thermoplastic elastomer EL3, an ethylene-methyl acrylate copolymer (manufactured by ARKEMA K. K., lotryl 29MA03) was prepared as a thermoplastic elastomer EL4, an ethylene-methyl acrylate-maleic anhydride copolymer (manufactured by ARKEMA K. K., lotader 3430) was prepared as a thermoplastic elastomer EL5, and an ethylene-ethyl acrylate-maleic anhydride copolymer (manufactured by ARKEMA K. K., lotader 4700) was prepared as a thermoplastic elastomer EL6.

Preparation of Other Compounds

A resin R1 (manufactured by NOF CORPORATION, MODIPER A4400) was prepared in which an acrylonitrile-styrene copolymer as a side chain was grafted onto an ethylene-glycidyl methacrylate copolymer as a main chain.

Production of Resin Composition

A resin composition (pellets) was obtained using a twin-screw kneader (manufactured by LABTECH ENGINEERING COMPANY LTD, LTE20-44) at a charge composition ratio and a cylinder temperature shown in Table 3.

Injection Molding

With the obtained pellets, an ISO multi-purpose dumbbell test piece (dimensions of measurement part: 10 mm width/4 mm thickness) was molded under conditions of a cylinder temperature shown in Table 3 and a mold temperature of 60° C. using an injection molding machine (manufactured by NISSEI PLASTIC INDUSTRIAL CO., LTD., NEX500I).

Evaluation Test

Appearance

A surface of the obtained ISO multi-purpose dumbbell test piece was observed to confirm the presence or absence of pearly luster. A situation in which no pearly luster was recognized was evaluated as “good”, a situation in which slight pearly luster was recognized was evaluated as “slight pearly luster”, and a situation in which pearly luster was clearly recognized was evaluated as “pearly luster”. The evaluation results are described in Table 3.

Bleedout

A letter was written on the surface of the obtained ISO multi-purpose dumbbell test piece using oil-based ink, and the test piece was left for 1,000 hours under conditions of 65° C./90% RH. A bleedout state of the surface of the test piece was evaluated in accordance with the following standards.

Not occurred: The letter of the oil-based ink does not bleed. There is no visual bleedout of the plasticizer.

Occurred: The letter of the oil-based ink bleeds, or bleedout of the plasticizer is clearly observed visually.

Tensile Elastic Modulus

The tensile elastic modulus of the obtained ISO multi-purpose dumbbell test piece was measured by a method based on ISO527 with the use of a universal testing device (manufactured by SHIMADZU CORPORATION, AUTOGRAPH AG-X plus). The results are described in Table 3.

Tensile Break Strain (%)

The tensile break strain of the obtained ISO multi-purpose dumbbell test piece was measured by a method based on ISO527 with the use of a universal testing device (manufactured by SHIMADZU CORPORATION, AUTOGRAPH AG-X plus). The results are described in Table 3.

Charpy Impact Strength (kJ/m²)

The obtained ISO multi-purpose dumbbell test piece was processed into a notched impact test piece by a method based on ISO179, and subjected to the measurement of a notched impact strength at 23° C. with an impact strength measurement device (manufactured by TOYO SEIKI SEISAKU-SHO, LTD., CHARPY AUTO-IMPACT TESTER CHN3). The results are described in Table 3.

TABLE 3

| | | | | | | Cylinder | | | Tensile | Tensile | Charpy |
|---|---|---|---|---|---|---|---|---|---|---|---|
| | Cellulose | | | | | Tempera- | | | Elastic | Break | Impact |
| | Ester | | Specific | Thermoplastic | | ture | | | Modulus | Strain | Strength |
| | Compound | Plasticizer | Resin | Elastomer | Other | (° C.) | Appearance | Bleeding | (MPa) | (%) | (kJ/m2) |
| Example 1 | CE1 = 70 | — | AS1 = 30 | | — | 230 | Good | Not | 2570 | 32 | 5.55 |
| | | | | | | | | Occurred | | | |
| Example 2 | CE1 = 97 | — | AS1 = 3 | EL1 = 10 | — | 230 | Good | Not | 1950 | 50 | 11.7 |
| | | | | | | | | Occurred | | | |
| Example 3 | CE1 = 95 | — | AS1 = 5 | EL1 = 10 | — | 230 | Good | Not | 2040 | 44 | 11.5 |
| | | | | | | | | Occurred | | | |
| Example 4 | CE1 = 80 | — | AS1 = 20 | EL1 = 10 | — | 230 | Good | Not | 2330 | 35 | 10.6 |
| | | | | | | | | Occurred | | | |
| Example 5 | CE1 = 70 | — | AS1 = 30 | EL1 = 10 | — | 230 | Good | Not | 2410 | 32 | 8.92 |
| | | | | | | | | Occurred | | | |
| Example 6 | CE1 = 60 | — | AS1 = 40 | EL1 = 10 | — | 230 | Slight | Not | 2480 | 26 | 6.33 |
| | | | | | | | Pearly | Occurred | | | |
| | | | | | | | Luster | | | | |
| Example 7 | CE1 = 80 | — | AS3 = 20 | EL1 = 10 | — | 230 | Good | Not | 2310 | 36 | 10.8 |
| | | | | | | | | Occurred | | | |
| Example 8 | CE1 = 80 | — | AS4 = 20 | EL1 = 10 | — | 230 | Good | Not | 2350 | 29 | 10.0 |
| | | | | | | | | Occurred | | | |
| Example 9 | CE1 = 80 | — | AS5 = 20 | EL1 = 10 | — | 230 | Good | Not | 2340 | 27 | 9.71 |
| | | | | | | | | Occurred | | | |
| Example 10 | CE2 = 80 | — | AS1 = 20 | EL1 = 10 | — | 230 | Good | Not | 2630 | 18 | 10.7 |
| | | | | | | | | Occurred | | | |
| Example 11 | CE3 = 80 | — | AS1 = 20 | EL1 = 10 | — | 230 | Good | Not | 2230 | 58 | 11.1 |
| | | | | | | | | Occurred | | | |
| Example 12 | CE1 = 80 | — | AS1 = 20 | EL1 = 0.3 | — | 230 | Good | Not | 2510 | 32 | 6.01 |
| | | | | | | | | Occurred | | | |
| Example 13 | CE1 = 80 | — | AS1 = 20 | EL1 = 1 | — | 230 | Good | Not | 2450 | 36 | 7.19 |
| | | | | | | | | Occurred | | | |
| Example 14 | CE1 = 80 | — | AS1 = 20 | EL1 = 20 | — | 230 | Good | Not | 2080 | 52 | 14.0 |
| | | | | | | | | Occurred | | | |
| Example 15 | CE1 = 80 | — | AS1 = 20 | EL1 = 30 | — | 230 | Good | Not | 1940 | 51 | 17.5 |
| | | | | | | | | Occurred | | | |
| Example 16 | CE1 = 80 | — | AS1 = 20 | EL2 = 10 | — | 230 | Good | Not | 2350 | 36 | 10.2 |
| | | | | | | | | Occurred | | | |
| Example 17 | CE1 = 80 | — | AS1 = 20 | EL3 = 10 | — | 230 | Good | Not | 2400 | 31 | 11.1 |
| | | | | | | | | Occurred | | | |
| Example 18 | CE1 = 80 | — | AS1 = 20 | EL4 = 10 | — | 230 | Good | Not | 2330 | 30 | 9.70 |
| | | | | | | | | Occurred | | | |
| Example 19 | CE1 = 80 | — | AS1 = 20 | EL5 = 10 | — | 230 | Good | Not | 2380 | 31 | 10.3 |
| | | | | | | | | Occurred | | | |
| Example 20 | CE1 = 80 | — | AS1 = 20 | EL6 = 10 | — | 230 | Good | Not | 2320 | 27 | 9.20 |
| | | | | | | | | Occurred | | | |
| Example 21 | CE4 = 73 | PL1 = 7 | AS1 = 20 | EL1 = 10 | — | 260 | Good | Not | 2920 | 10 | 6.01 |
| | | | | | | | | Occurred | | | |
| Example 22 | CA4 = 66 | PL1 = 14 | AS1 = 20 | EL1 = 10 | — | 230 | Good | Occurred | 2580 | 10 | 7.06 |
| Reference | CE1 = 100 | — | — | — | — | 230 | Good | Not | 2020 | 51 | 6.28 |
| Example 1 | | | | | | | | Occurred | | | |
| Reference | CE1 = 100 | — | — | EL1 = 10 | — | 230 | Good | Not | 1900 | 50 | 12.1 |
| Example 2 | | | | | | | | Occurred | | | |
| Comparative | CE1 = 70 | — | AS6 = 30 | — | — | 230 | Pearly | Not | 2480 | 7 | 3.51 |
| Example 1 | | | | | | | Luster | Occurred | | | |
| Comparative | CE1 = 97 | — | AS6 = 3 | EL1 = 10 | — | 230 | Pearly | Not | 1980 | 32 | 8.44 |
| Example 2 | | | | | | | Luster | Occurred | | | |
| Comparative | CE1 = 95 | — | AS6 = 5 | EL1 = 10 | — | 230 | Pearly | Not | 2000 | 28 | 8.12 |
| Example 3 | | | | | | | Luster | Occurred | | | |
| Comparative | CE1 = 80 | — | AS6 = 20 | EL1 = 10 | — | 230 | Pearly | Not | 2290 | 12 | 4.76 |
| Example 4 | | | | | | | Luster | Occurred | | | |
| Comparative | CE1 = 70 | — | AS6 = 30 | EL1 = 10 | — | 230 | Pearly | Not | 2350 | 9 | 4.38 |
| Example 5 | | | | | | | Luster | Occurred | | | |
| Comparative | CE1 = 60 | — | AS6 = 40 | EL1 = 10 | — | 230 | Pearly | Not | 2510 | 9 | 4.32 |
| Example 6 | | | | | | | Luster | Occurred | | | |
| Comparative | CE1 = 80 | — | AS2 = 20 | EL1 = 10 | — | 230 | Good | Not | 1780 | 11 | 3.78 |
| Example 7 | | | | | | | | Occurred | | | |
| Reference | CE2 = 100 | — | — | — | — | 230 | Good | Not | 2600 | 20 | 6.71 |
| Example 3 | | | | | | | | Occurred | | | |
| Reference | CE3 = 100 | — | — | — | — | 230 | Good | Not | 2190 | 65 | 8.37 |
| Example 4 | | | | | | | | Occurred | | | |
| Reference | CE4 = 91 | PL1 = 9 | — | — | — | 260 | Good | Not | 3100 | 8 | 3.47 |
| Example 5 | | | | | | | | Occurred | | | |
| Reference | CA4 = 83 | PL1 = 17 | — | — | — | 230 | Good | Occurred | 2600 | 13 | 7.21 |
| Example 6 | | | | | | | | | | | |
| Comparative | CE1 = 80 | — | AS6 = 20 | EL2 = 10 | — | 230 | Pearly | Not | 2300 | 11 | 4.99 |
| Example 8 | | | | | | | Luster | Occurred | | | |
| Comparative | CE1 = 80 | — | AS6 = 20 | EL3 = 10 | — | 230 | Pearly | Not | 2310 | 13 | 5.16 |
| Example 9 | | | | | | | Luster | Occurred | | | |
| Comparative | CE1 = 80 | — | AS6 = 20 | EL4 = 10 | — | 230 | Pearly | Not | 2260 | 9 | 4.68 |
| Example 10 | | | | | | | Luster | Occurred | | | |
| Comparative | CE1 = 80 | — | AS6 = 20 | EL5 = 10 | — | 230 | Pearly | Not | 2310 | 13 | 4.86 |
| Example 11 | | | | | | | Luster | Occurred | | | |
| Comparative | CE1 = 80 | — | AS6 = 20 | EL6 = 10 | — | 230 | Pearly | Not | 2270 | 10 | 4.61 |
| Example 12 | | | | | | | Luster | Occurred | | | |
| Comparative | CE1 = 70 | — | AS6 = 30 | — | R1 = 0.1 | 230 | Pearly | Not | 2420 | 10 | 3.87 |
| Example 13 | | | | | | | Luster | Occurred | | | |
| Comparative | CE1 = 70 | — | AS6 = 30 | — | R1 = 20 | 230 | Slight | Not | 2200 | 14 | 5.13 |
| Example 14 | | | | | | | Pearly | Occurred | | | |
| | | | | | | | Luster | | | | |
| Comparative | CE1 = 70 | — | AS6 = 30 | — | R1 = 25 | 230 | Slight | Not | 2170 | 13 | 5.21 |
| Example 15 | | | | | | | Pearly | Occurred | | | |
| | | | | | | | Luster | | | | |
| Comparative | CE1 = 70 | — | AS6 = 30 | EL1 = 10 | R1 = 0.1 | 230 | Pearly | Not | 2220 | 11 | 4.14 |
| Example 16 | | | | | | | Luster | Occurred | | | |
| Comparative | CE1 = 70 | — | AS6 = 30 | EL1 = 10 | R1 = 20 | 230 | Slight | Not | 1990 | 16 | 5.49 |
| Example 17 | | | | | | | Pearly | Occurred | | | |
| | | | | | | | Luster | | | | |
| Comparative | CE1 = 70 | — | AS6 = 30 | EL1 = 10 | R1 = 25 | 230 | Slight | Not | 1970 | 16 | 5.57 |
| Example 18 | | | | | | | Pearly | Occurred | | | |
| | | | | | | | Luster | | | | |
| Comparative | CE4 = 73 | PL1 = 7 | AS6 = 20 | EL1 = 10 | — | 260 | Pearly | Not | 2840 | 5 | 4.91 |
| Example 19 | | | | | | | Luster | Occurred | | | |
| Comparative | CE4 = 66 | PL1 = 14 | AS6 = 20 | EL1 = 10 | — | 230 | Pearly | Occurred | 2510 | 4 | 5.77 |
| Example 20 | | | | | | | Luster | | | | |

According to the resin compositions of Examples 1 to 33, a molded article which has more excellent stiffness (tensile elastic modulus) than that of Reference Examples 1 to 4 is obtained in the comparison between the examples having the same thermoplastic elastomer content, and a molded article which has higher tensile break strain than that of Comparative Examples 1 to 18 is obtained.

According to the resin compositions of Examples 1 to 33, a molded article which has more excellent tensile elastic modulus and Charpy impact strength than those of Comparative Examples 1 to 18 is obtained in the comparison between the examples having the same specific resin content and the same thermoplastic elastomer content.

According to the resin compositions of Examples 1 to 33, a molded article in which the generation of pearly luster is suppressed is obtained.

What is claimed is:

1. A resin composition comprising:
a cellulose ester compound; and
a styrene-acrylonitrile resin having a weight average molecular weight of 50,000 or greater to 200,000 or less.

2. The resin composition according to claim 1,
wherein a ratio of a total mass of the styrene-acrylonitrile resin with respect to a total of a total mass of the cellulose ester compound and the total mass of the styrene-acrylonitrile resin is 0.05 or greater to 0.35 or less.

3. The resin composition according to claim 1,
wherein a ratio of a total mass of the styrene-acrylonitrile resin with respect to a total of a total mass of the cellulose ester compound and the total mass of the styrene-acrylonitrile resin is 0.10 or greater to 0.30 or less.

4. The resin composition according to claim 1,
wherein the cellulose ester compound includes at least one selected from the group consisting of cellulose acetate propionate and cellulose acetate butyrate.

5. The resin composition according to claim 1, further comprising:
a thermoplastic elastomer having a constituent unit derived from a (meth)acrylic acid ester compound.

6. The resin composition according to claim 5,
wherein the thermoplastic elastomer has a core-shell structure having a core part and a shell layer.

7. The resin composition according to claim 5,
wherein the thermoplastic elastomer includes a constituent unit derived from an olefin compound.

8. The resin composition according to claim 7,
wherein the constituent unit derived from an olefin compound is a constituent unit derived from at least one compound selected from the group consisting of ethylene, α-olefin, and butadiene.

9. The resin composition according to claim 5,
wherein a ratio of a total mass of the thermoplastic elastomer with respect to a total of a total mass of the cellulose ester compound and a total mass of the styrene-acrylonitrile resin is 0.01 or greater to 0.20 or less.

10. The resin composition according to claim 1,
wherein a content of the cellulose ester compound with respect to a total mass of the resin composition is 60 mass % or greater to 95 mass % or less.

11. A molded article comprising:
the resin composition according to claim 1.

12. A resin composition comprising:
a cellulose ester compound including at least one selected from the group consisting of cellulose acetate propionate and cellulose acetate butyrate;
a styrene-acrylonitrile resin having a weight average molecular weight of 50,000 or greater to 200,000 or less; and
a thermoplastic elastomer having a constituent unit derived from a (meth)acrylic acid ester compound.
